(19) United States
(12) Patent Application Publication
(10) Pub. No.: US 2020/0272001 A1
(43) Pub. Date: Aug. 27, 2020

(54) DISPLAY DEVICE

(71) Applicant: Sharp Kabushiki Kaisha, Sakai City (JP)

(72) Inventor: Takeshi KAMEDA, Sakai City (JP)

(21) Appl. No.: 16/800,075

(22) Filed: Feb. 25, 2020

Related U.S. Application Data
(60) Provisional application No. 62/810,420, filed on Feb. 26, 2019.

(51) Int. Cl. G02F 1/1362; G02F 1/1333; G02F 1/1345

(52) U.S. Cl. CPC G02F 1/136204; G02F 1/13338; G02F 1/13452; G02F 1/133308

(57) ABSTRACT

Provided is a display device in which static electricity from outside is blocked and a display module has a narrower frame area. The display device includes a display module, and a display panel protection member made of a conductive material. At least a part of a side surface of the display module is covered with the display panel protection member. The display panel protection member is connected to a ground potential line, and blocks static electricity from outside.

### TECHNICAL FIELD

The present invention disclosed below relates to a display device.

### BACKGROUND ART

A variety of techniques have been proposed for protecting elements in a display from external noises such as static electricity. For example, JP-A-2010-218542discloses a display including a touch panel in which shielding electrodes for blocking noises caused by static electricity are formed on the touch panel. The shielding electrodes in this display are provided along a periphery of a frame area on the surface of the touch panel substrate. Therefore, the shielding electrodes thus provided allow noises caused by static electricity from outside to be reduced. This, however, requires an area where the shielding electrodes are provided, thereby making it difficult to narrow the frame area of the display.

### SUMMARY

A display device made in light of the above-described problem includes a display panel; and a display panel protection member. The display panel protection member is made of a conductive material, covers at least a part of side surfaces of the display panel, and is connected to a ground potential.

The above-described configuration makes it possible to block static electricity from outside, and at the same time, to narrow the frame area.

### BRIEF DESCRIPTION OF DRAWINGS

FIG. 1 is a plan view illustrating a schematic configuration of a display device in Embodiment 1.

FIG. 2 is a schematic cross-sectional view illustrating the display device illustrated in FIG. 1, taken along line A-A.

FIG. 3 is a cross-sectional view illustrating a display module and a second protection member that are extracted from FIG. 2.

FIG. 4 is a schematic plan view of a touch panel illustrated in FIG. 2.

FIG. 5A is a schematic cross-sectional view of the touch panel illustrated in FIG. 4, taken along line B-B.

FIG. 5B is a schematic cross-sectional view of the touch panel illustrated in FIG. 4, taken along line C-C.

FIG. 6 is a cross-sectional view illustrating a schematic configuration of a display device in Embodiment 2.

FIG. 7A is a schematic plan view illustrating the counter substrate, the active matrix substrate, and an electrostatic protection member illustrated in FIG. 6.

FIG. 7B is a schematic cross-sectional view taken along line D-D illustrated in FIG. 7A.

FIG. 8 is a schematic cross-sectional view of a display device in Embodiment 3.

FIG. 9 is a schematic cross-sectional view of a display device in Embodiment 3, which is a display device in which an electrostatic protection member different from that in FIG. 8 is provided.

FIG. 10 is a schematic plan view illustrating a touch panel in Modification Example (1).

### EMBODIMENTS

The following describes display devices according to embodiments in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, dimension ratios of constituent members illustrated in the drawings do not necessarily indicate actual dimension ratios.

### Embodiment 1

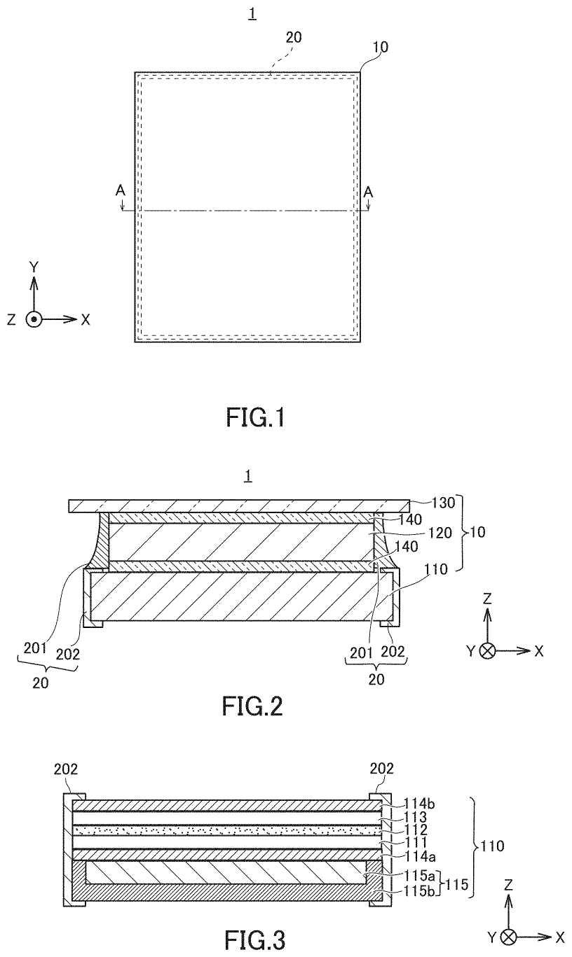

FIG. 1 is a schematic plan view illustrating a schematic configuration of a display device according to the present embodiment. The display device 1 is a so-called touch-panel-equipped display device that has an image displaying function of displaying an image, and a touch detecting function of detecting a touch position that is a position touched by a user.

The display device 1 includes a touch-panel-equipped display module 10 that includes a touch panel, and an electrostatic protection member 20. The electrostatic protection member 20 is provided along side surfaces of the touch-panel-equipped display module 10. The following description describes the touch-panel-equipped display module 10 and the electrostatic protection member 20 more specifically.

### (Configuration of Touch-Panel-Equipped Display Module 10)

FIG. 2 is a schematic cross-sectional view of the display device 1 illustrated in FIG. 1, taken along line A-A. As illustrated in FIG. 2, the touch-panel-equipped display module 10 includes a display module 110, a touch panel 120, and a cover glass 130.

Adhesive layers 140 having translucency are provided between the display module 110 and the touch panel 120, as well as between the touch panel 120 and the cover glass 130. The display module 110, the touch panel 120, and the cover glass 130 are tightly bonded together with the adhesive layers 140. In other words, in the present embodiment, the display device 1 includes the touch-panel-equipped display module 10 of an out-cell type in which the touch panel 120 is provided on the display module 110.

In this example, the display module 110 has a width in the X-axis direction greater than that of the touch panel 120, and the cover glass 130 has a width in the X-axis direction greater than that of the display module 110.

Side surfaces of the display module 110 and the touch panel 120 are covered with the electrostatic protection member 20. The electrostatic protection member 20 is composed of a touch panel protection member 201 and a display panel protection member 202. More specific configurations of the touch panel protection member 201 and the display panel protection member 202 will be described later.

### (Configuration of Display Module 110)

Here, the following description describes the configurations of the display module 110. FIG. 3 is a cross-sectional view illustrating the display module 110 and the display panel protection member 202 that are extracted from FIG. 2.

As illustrated in FIG. 3, the display module 110 includes an active matrix substrate 111 as a display panel, a liquid crystal layer 112, and a counter substrate 113 as a display panel, a pair of polarizing plates 114a, 114b, as well as a backlight module 115.

Though the illustration is omitted, the active matrix substrate 111 includes a plurality of gate lines and a plurality of source lines on a glass substrate having translucency. The active matrix substrate 111 has a display area where a plurality of pixels defined by gate lines and source lines are formed. In each pixel, a switching element connected to a gate line and a source line that correspond to the pixel, and a pixel electrode connected with the switching element, are provided.

Further, in a frame area of the active matrix substrate 111, a gate driver for scanning the gate lines, a source driver for applying gray level voltages to the source lines, and a display control circuit that is connected with the gate driver and the source driver, are provided (illustration of these is omitted). These may be directly mounted on the active matrix substrate 111, or may be incorporated in a flexible printed circuit (FPC) and connected with the active matrix substrate 111.

The counter substrate 113 includes a common electrode formed with a transparent conductive film, and color filters of red (R), green (G), and blue (B) (illustration of these is omitted). The common electrode is arranged so as to overlap with an entirety of the display area on the active matrix substrate 111 when viewed in a plan view. Each of the color filters R, G, and B is provided so as to be opposed to one pixel corresponding to the same.

Each of the polarizing plates 114a, 114b is formed with a laminate obtained by laminating a plurality of optical films. The polarizing plates 114a, 114b are arranged so as to overlap with an entirety of the display area on the active matrix substrate 111 when viewed in a plan view, and transmit light polarized in a specific direction, among the light emitted from the backlight module 115.

The backlight module 115 includes a backlight 115a and a bezel 115b that houses the backlight 115a.

The backlight 115a includes a plurality of light sources and a light guide plate (illustration of these is omitted). In this example, the light sources are formed with light-emitting diodes (LEDs); the type of the light sources, however, is not limited to this.

The bezel 115b is made of a metal material, and covers side surfaces and a bottom surface of the backlight 115a. The bottom surface of the bezel 115b is connected to a line (ground potential line) to which a predetermined reference potential (hereinafter referred to as a ground potential) is applied.

### (Configuration of Touch Panel 120)

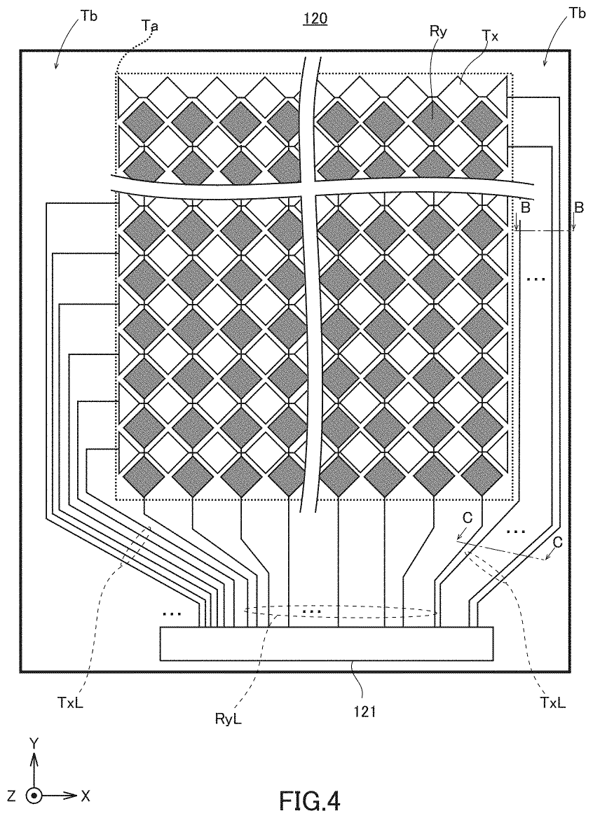

Next, the following description describes a configuration of the touch panel 120. FIG. 4 is a schematic plan view of the touch panel 120.

As illustrated in FIG. 4, the touch panel 120 includes a plurality of first electrodes Ry, a plurality of second electrodes Tx, a plurality of first electrode lines RyL, a plurality of second electrode lines TxL, and a controller 121.

The first electrodes Ry and the second electrodes Tx are arranged so that the first electrodes Ry and the second electrodes Tx form a lattice pattern. On the touch panel 120, an area Ta where the first electrodes Ry and the second electrodes Tx are arranged is an area that is used for detecting a touch of a user's finger or the like. Hereinafter, the area Ta is referred to as an active area Ta, and an area outside the active area is referred to as a frame area (non-active area) Tb.

Among the first electrodes Ry, the first electrodes Ry arrayed in the Y axis direction are concatenated with one another, and are connected electrically with one first electrode line RyL corresponding to the same. Among the second electrodes Tx, the second electrodes Tx arrayed in the X axis direction are concatenated with one another, and are connected electrically with one second electrode line TxL corresponding to the same.

The first electrodes Ry and the second electrodes Tx are formed with, for example, a mesh pattern of thin metal lines made of copper, silver, or the like.

The first electrode lines RyL and the second electrode lines TxL are metal lines made of the same metal material as that of the first electrodes Ry and the second electrodes Tx in this example.

Each first electrode line RyL extends from an end thereof on one side to an area where the controller 121 is provided, in the frame area Tb. Each second electrode lines TxL extends from a left-side part (on the X-axis negative direction side) or a right-side part (on the X-axis positive direction side) of the frame area Tb with respect to the active area Ta, to the controller 121.

Each of the first electrode lines RyL and the second electrode lines TxL is connected with the controller 121. The controller 121 sequentially selects the second electrode lines TxL and applies a predetermined voltage thereto, so as to cause electric fields to be generated to the second electrodes Tx connected with the second electrode lines TxL. The controller 121 sequentially selects the first electrode line RyL and receives output signals corresponding to capacitances at the first electrodes Ry. When a user's finger or the like touches a vicinity of the second electrode Tx where a predetermined electric field is generated, a change occurs to the capacitance of the first electrode Ry in the vicinity of the contact position. The position where a change greater than a predetermined value occurs to the capacitance is detected as a contact position by the controller 121, based on the output signals acquired from the second electrode lines TxL and the respective first electrode lines RyL to which the predetermined electric fields are applied.

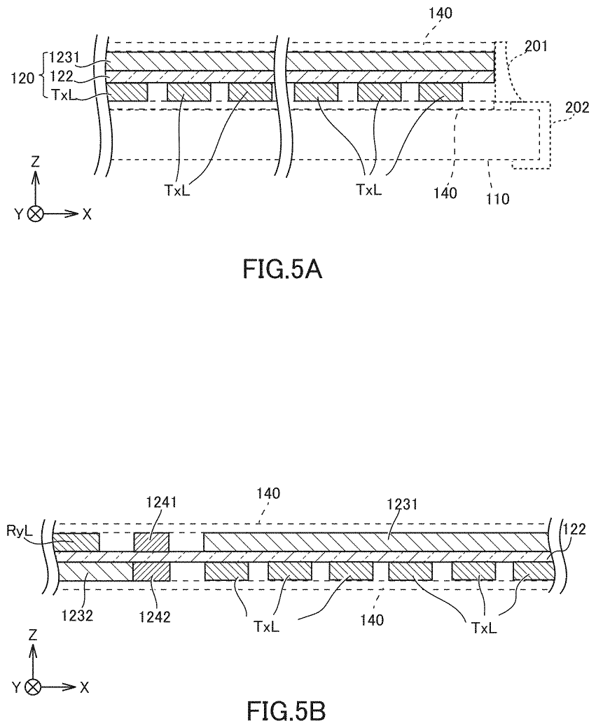

Next, the following description describes a cross-sectional structure of the touch panel 120. FIG. 5A is a schematic cross-sectional view of the touch panel 120 illustrated in FIG. 4, taken along line B-B, and FIG. 5B is a schematic cross-sectional view of the touch panel 120 illustrated in FIG. 4, taken along line C-C. Incidentally, for convenience of explanation, FIG. 5A illustrates the adhesive layers 140, the touch panel protection member 201, and the display module 110 with broken lines, in addition to the configuration of the touch panel 120, and FIG. 5B illustrates the adhesive layers 140 with broken lines.

As illustrated in FIGS. 5 A and 5B, the touch panel 120 includes a substrate 122 made of, for example, polyethylene terephthalate (PET) or the like.

FIGS. 5A and 5B illustrate the cross section of the touch panel 120 in the frame area Tb outside the active area Ta where the first electrodes Ry and the second electrodes Tx are provided. Therefore, though not illustrated in these drawings, the first electrodes Ry are arranged on one of surfaces of the substrate 122 (hereinafter this surface is referred to as “first surface”), and the second electrodes Tx are arranged on the other surface of the substrate 122 (hereinafter referred to as “second surface”). Concatenated parts of the first electrodes Ry concatenated with one another, and concatenated parts of the second electrodes Tx concatenated with one another are arranged so as to overlap when viewed in a plan view, with the substrate 122 being interposed therebetween.

As illustrated in FIGS. 5A and 5B, a mesh-form metal film 1231 is provided on the first surface of the substrate 122, and a mesh-form metal film 1232 is provided on the second surface of the substrate 122. The metal films 1231 and 1232 are connected with ground potential lines, respectively.

Further, as illustrated in FIGS. 5A and 5B, the first electrode line RyL is arranged on the first surface of the substrate 122 at a position that is opposed to the metal film 1232, and a plurality of the second electrode lines TxL are arranged on the second surface of the substrate 122 so as to be separated from one another, at positions that are opposed to the metal film 1231. In other words, in the frame area Tb of the touch panel 120, the metal film 1232 is provided in an area where the first electrode line RyL is provided, and the metal film 1231 is provided in an area where the second electrode lines TxL are provided.

As illustrated in FIG. 4, the first electrode lines RyL and the second electrode lines TxL are arranged in the area where the controller 121 is arranged, in the frame area Tb. In other words, as illustrated in FIG. 5B, the first electrode lines RyL and the second electrode lines TxL are arranged at positions that do not overlap with one another when viewed in a plan view. Further, as illustrated in FIG. 5B, a metal line 1241 and a metal line 1242 are provided between the first electrode line RyL and one of the second electrode lines TxL adjacent to the foregoing first electrode line RyL. The metal line 1241 is arranged on the first surface of the substrate 122, and the metal line 1242 is arranged on the second surface of the substrate 122. The metal films 1241 and 1242 are connected with ground potential lines (not illustrated), respectively.

In this way, the metal line 1241 and the metal line 1242 are arranged between the first electrode line RyL and the second electrode line TxL, which makes it unlikely that capacitive coupling would occur between the first electrode line RyL and the second electrode line TxL that are adjacent to each other. Further, the metal film 1232 is arranged over the first electrode lines RyL, and the metal film 1231 is arranged over the second electrode lines TxL, whereby the first electrode lines RyL and the second electrode lines TxL are shielded by the metal film 1231 or the metal film 1232. Therefore, as compared with a case where the first electrode lines RyL and the second electrode lines TxL are not shielded by the metal film 1231 or the metal film 1232, it is unlikely that electromagnetic disturbance noise would penetrate into the first electrode lines RyL and the second electrode lines TxL, which makes it unlikely that radiation noise in the touch panel 120 would be released to outside.

### (Configuration of Electrostatic Protection Member 20)

The following description describes a structure of the touch panel protection member 201 and the display panel protection member 202.

As illustrated in FIGS. 2 and 5A, the touch panel protection member 201 covers an entirety of side surfaces of the touch panel 120. The touch panel protection member 201 is made of a resin containing a conductive material. More specifically, the touch panel protection member 201 is formed by, for example, adding a conductive filler such as carbon black particles or metal particles in a resin such as a liquid epoxy resin or an acrylic urethane resin, and thereafter, curing the resin with use of ultraviolet light (UV) or heat.

The display panel protection member 202 in this example is an adhesive tape called “rim tape”, and has conductivity. As illustrated in FIGS. 2 and 3, the display panel protection member 202 is caused to adhere to the display module 110 so as to covers an entirety of side surfaces thereof, thereby fixing each constituent member of the display module 110.

As the display panel protection member 202 is in contact with the bezel 115b (see FIG. 3), the display panel protection member 202 is connected to a ground potential line (not illustrated) via the bezel 115b. Besides, the touch panel protection member 201 and the display panel protection member 202 are concatenated with each other. The touch panel protection member 201 is therefore connected to the ground potential line via the display panel protection member 202.

The configuration of the display device 1 is as described above. In embodiment 1, the entire side surfaces of the touch panel 120 is covered with the touch panel protection member 201, the entire side surfaces of the display module 110 are covered with the display panel protection member 202, and the first protection member 201 is in contact with the display panel protection member 202 connected to the ground potential line. In other words, the side surfaces of the touch panel 120 and the display module 110 are shielded by the electrostatic protection member 20. It is therefore unlikely that static electricity would enter the touch panel 120 and the display module 110 from outside. Further, the touch panel protection member 201 is provided on the side surfaces of the touch panel 120, and the display panel protection member 202 is provided on the side surfaces of the display module 110. This makes it possible to cause the display device 1 to have a narrower frame, as compared with a configuration in which a member for blocking static electricity is arranged in the frame area Tb of the touch panel 120 or a frame area (not illustrated) of the display module 110.

### Embodiment 2

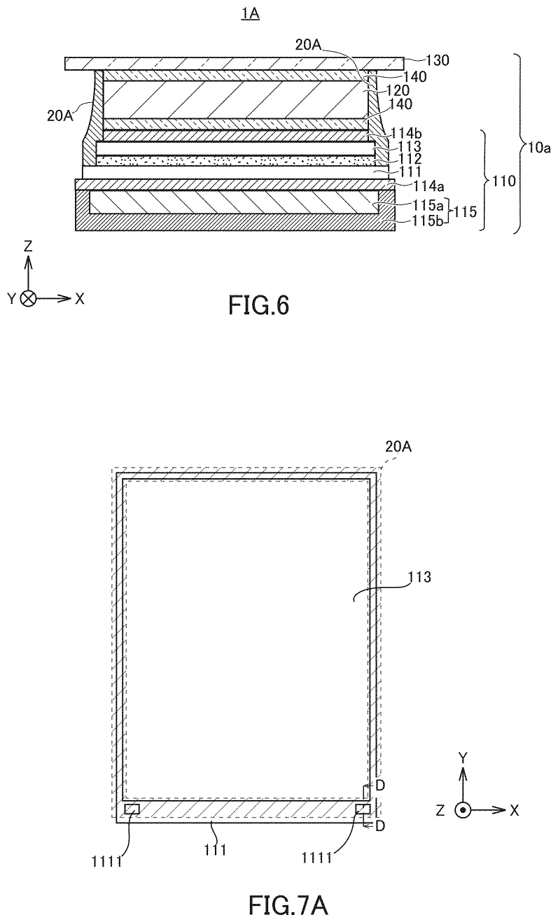

The present embodiment is described with reference to an exemplary electrostatic protection member having a configuration different from that in Embodiment 1 described above. FIG. 6 is a cross-sectional view illustrating a schematic configuration of a touch-panel-equipped display module in the present embodiment. In FIG. 6, the same constituent members as those in Embodiment 1 are denoted by the same reference symbols as those in Embodiment 1.

As illustrated in FIG. 6, a touch-panel-equipped display module 10a in the present embodiment includes an electrostatic protection member 20A. The electrostatic protection member 20A is different from the electrostatic protection member in Embodiment 1 in the point that the electrostatic protection member 20A covers an entirety of the side surfaces of the touch panel 120, but does not cover an entirety of the side surfaces of the display module 110. Further, the electrostatic protection member 20A is different from the electrostatic protection member in Embodiment 1 in the point that the display panel protection member and the touch panel protection member are integrally molded. The following description describes structures different from those in Embodiment 1.

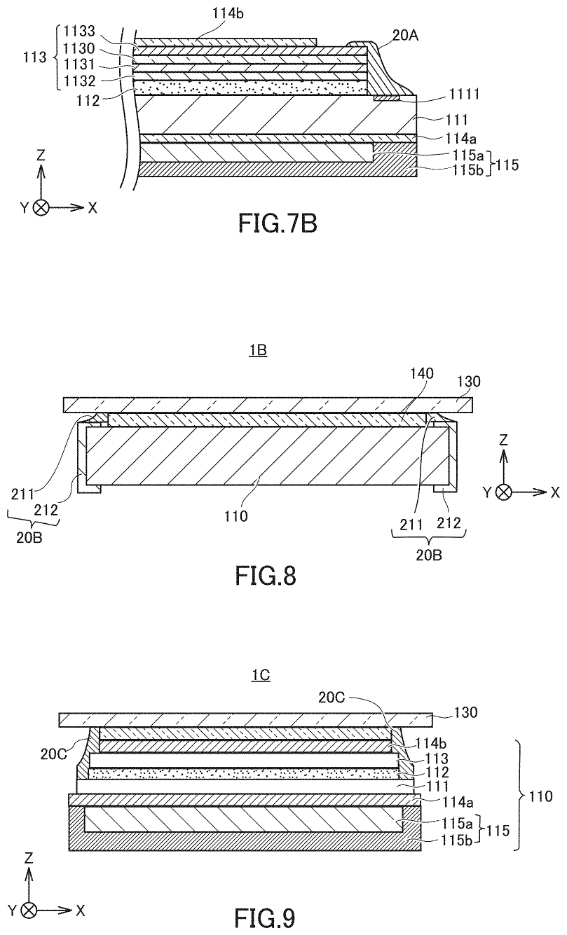

FIG. 7A is a schematic plan view illustrating the counter substrate 113 and the active matrix substrate 111, extracted from FIG. 6. FIG. 7B is a schematic cross-sectional view taken along line D-D illustrated in FIG. 7A. Incidentally, in FIG. 7A, an area where the electrostatic protection member 20A is provided is indicated by a broken line.

As illustrated in FIG. 7A and 7B, the active matrix substrate 111 has a greater size than that of the counter substrate 113 in the present embodiment. On a surface in the frame area of the active matrix substrate 111 that is not covered with the counter substrate 113, a plurality of electrodes 1111 (hereinafter referred to as “ground electrodes 1111”) connected to ground potential lines (not illustrated) are provided.

Further, in the present embodiment, as illustrated in FIG. 7B, the length in the Y-axis direction of the polarizing plate 114b is smaller than the length in the Y-axis direction of the counter substrate 113, whereby the surface of the counter substrate 113 is partially uncovered with the polarizing plate 114b.

Here, the following description describes the structure of the counter substrate 113. As illustrated in FIG. 7B, the counter substrate 113 includes a substrate 1130 having translucency, made of glass or the like. On a surface on the liquid crystal layer 112 side of the substrate 1130, a color filter 1131 and a common electrode 1132 are laminated. Besides, an electrode 1133 is provided on a surface on the polarizing plate 114b side of the substrate 1130. The electrode 1133 is connected to the ground electrode 1111 through the electrostatic protection member 20A (hereinafter the electrode 1133 is referred to as “ground electrode 1133”).

Incidentally, though the illustration is omitted in FIG. 7B, the common electrode 1132 is smaller than the substrate 1130, an alignment film is formed around a periphery of the common electrode 1132, and a spacer is provided around a periphery of the liquid crystal layer 112. Therefore, the common electrode 1132 and the liquid crystal layer 112 are not in contact with the electrostatic protection member 20A.

The color filter 1131 includes color filters having colors of red (R), green (G), and blue (B), respectively. The color filters of each color are provided so as to correspond to the pixels formed on the active matrix substrate 111, respectively.

The common electrode 1132 is formed with a transparent conductive film made of ITO or the like. The common electrode 1132 is arranged on the color filter 1131 so as to overlap with an entirety of the display area formed on the active matrix substrate 111, when viewed in a plan view. A predetermined voltage is applied to the common electrode 1132 by a display control circuit (not illustrated) provided on the active matrix substrate 111.

The ground electrode 1133 is formed with a transparent conductive film made of ITO or the like, over an entirety of the surface on the polarizing plate 114b of the substrate 1130. As illustrated in FIG. 7B, a part of the surface of the ground electrode 1133 that is not covered with the polarizing plate 114b is exposed.

The electrostatic protection member 20A is formed with, for example, silver (Ag) paste. The electrostatic protection member 20A covers the ground electrodes 1111 provided on the active matrix substrate 111, and the ground electrode 1133 provided on the counter substrate 113. More specifically, as illustrated in FIG. 7A, the counter substrate 113 and the active matrix substrate 111 have rectangular shapes when viewed in a plan view. Among the side surfaces on four sides of the active matrix substrate 111, a part thereof on three sides where the ground electrodes 1111 are not provided is covered with the electrostatic protection member 20A; and a part of the top surface of the active matrix substrate 111, on the side where the ground electrodes 1111 are provided, is covered with the electrostatic protection member 20A. Further, the side surfaces on the four sides of the counter substrate 113 are covered with the electrostatic protection member 20A. The ground electrodes 1111 and the ground electrode 1133 are electrically connected with each other through the electrostatic protection member 20A. The electrostatic protection member 20A and the ground electrode 1133 are connected to the ground potential line (not illustrated) connected to the ground electrodes 1111.

In other words, in this example, the part of the electrostatic protection member 20A that covers the four side surfaces on the counter substrate 113, the three side surfaces of the active matrix substrate 111, and a part of the surface of the active matrix substrate 111 on a side where the ground electrodes 1111 are provided functions as the display panel protection member. Further, the part of the electrostatic protection member 20A that covers the side surfaces of the touch panel 120 functions as the touch panel protection member.

In Embodiment 2 described above, as illustrated in FIGS. 6, 7A, and 7B, the electrostatic protection member 20A covers the ground electrode 1111 on the active matrix substrate 111, and the ground electrode 1133 on the counter substrate 113, as well as the three side surfaces of the display module 110, and the four side surfaces of the touch panel 120. This therefore makes it possible to cause the touch panel 120 to have a narrower frame area Tb, as compared with a case where a member for blocking static electricity is formed in the frame area Tb (see FIG. 4) of the touch panel 120. Further, it is unlikely that static electricity from outside would enter the touch panel 120 and the display module 110.

Incidentally, the position where the ground electrode 1111 on the active matrix substrate 111 side is provided is not limited to the position described above. Any configuration may be applicable as long as the ground electrode 1111 is exposed on a surface in the frame area of the active matrix substrate 111 so that conduction with the ground electrode 1133 on the counter substrate 113 side can be achieved through the electrostatic protection member 20A.

Further, in Embodiment 2 described above, the configuration may be also such that the electrostatic protection member 20A covers all of the side surfaces of the touch panel 120 and the display module 110 so as to cover the ground electrodes 1111 and the ground electrode 1133.

Still further, in Embodiment 2 described above, the configuration may be also such that rim tapes having conductivity are arranged on the ground electrodes 1111 and the electrostatic protection member 20A covers these.

### Embodiment 3

Embodiments 1 and 2 described above are described with reference to a display device where the touch panel 120 is arranged on the display module 110, but the display device may be without the touch panel 120. The following description describes an exemplary display device in the present embodiment.

FIG. 8 is a schematic cross-sectional view illustrating a display device in the present embodiment. In FIG. 8, the same constituent members as those in Embodiment 1 are denoted by the same reference symbols as those in Embodiment 1.

As illustrated in FIG. 8, a display device 1 B is different from the display device 1 of Embodiment 1 in the point that the touch panel 120 (see FIG. 2), and the adhesive layer 140 (see FIG. 2) between the touch panel 120 and the cover glass 130, are not provided on the display module 110.

In the display device 1B, an electrostatic protection member 20B is composed of a first protection member 211 and a second protection member 212. The first protection member 211 is provided between the cover glass 130 and the second protection member 212 so as to be in contact with the second protection member 212. The first protection member 211 is made of a resin having conductivity, and the second protection member 212 is made of the same material as that of the display panel protection member 202 in Embodiment 1.

In this example, the electrostatic protection member 20B functions as the display panel protection member. The side surfaces of the display module 110 are covered with the electrostatic protection member 20B, and this makes it possible to cause the display module 110 to have a narrower frame, as compared with a configuration in which a member for blocking static electricity is formed in the frame area of the display module 110.

It should be noted that the same electrostatic protection member as that of Embodiment 2 may be used in place of the above-described electrostatic protection member 20B of the display device 1B. FIG. 9 illustrates a cross-sectional view in this case. Incidentally, in FIG. 9, the same constituent members as those in Embodiment 2 are denoted by the same reference symbols as those in Embodiment 2.

As illustrated in FIG. 9, a display device 10 in the present embodiment is different from the display device 1A (see FIG. 6) in Embodiment 2 in the point that the touch panel 120, and the adhesive layer 140 between the touch panel 120 and the cover glass 130, are not formed.

An electrostatic protection member 20C in the present embodiment is made of a conductive material such as silver paste, as is the case with the electrostatic protection member 20A in Embodiment 2. The electrostatic protection member 20C is formed between the cover glass 130 and the surface of the active matrix substrate 111 so as to be in contact with the side surfaces of the display module 110.

In this case, the electrostatic protection member 20C is provided along an outer circumference of the active matrix substrate 111, on the side surfaces of the counter substrate 113 and the liquid crystal layer 112, as well as the surface of the active matrix substrate 111. In other words, the electrostatic protection member 20C functions as the display panel protection member. In the present embodiment, the electrostatic protection member 20C is arranged in the frame area on the four sides of the active matrix substrate 111, and this makes it possible to cause the display module 110 to have a smaller frame area, as compared with a case where a member for blocking static electricity is arranged on the surface of the active matrix substrate.

Incidentally, Embodiment 3 described above is described with reference to a configuration where all of the side surfaces of the display module 110 are covered with the display panel protection member, but all of the side surfaces do not have to be covered with the display panel protection member. For example, in a case where a flexible substrate is connected to the frame area of the display module 110, the side surfaces other than the surface on the side where the flexible substrate is provided may be covered with the display panel protection member.

### MODIFICATION EXAMPLE

The embodiments described above are merely examples for implementing the present invention. The present invention, therefore, is not limited to the above-described embodiments, and the above-described embodiments can be appropriately varied and implemented without departing from the spirit and scope of the invention.

(1) In the touch panel 120 (see FIG. 4) in the above-described embodiments, the plurality of second electrode lines TxL connected, respectively, with the second electrodes Tx arrayed in the X-axis direction include the second electrode lines TxL that are arranged in a left-side area of the frame area Tb that is on the left side with respect to the active area Ta, and the second electrode lines TxL that are arranged in a right-side area of the frame area Tb that is on the right side with respect to the active area Ta. In other words, in this touch panel 120, the second electrode lines TxL are connected to ends on one side of the second electrodes Tx that are arrayed in the X-axis direction. The configuration of the touch panel, however, is not limited to this. For example, the configuration may be such that the second electrode lines TxL are connected to ends on both sides of the second electrodes Tx that are arrayed in the X-axis direction.

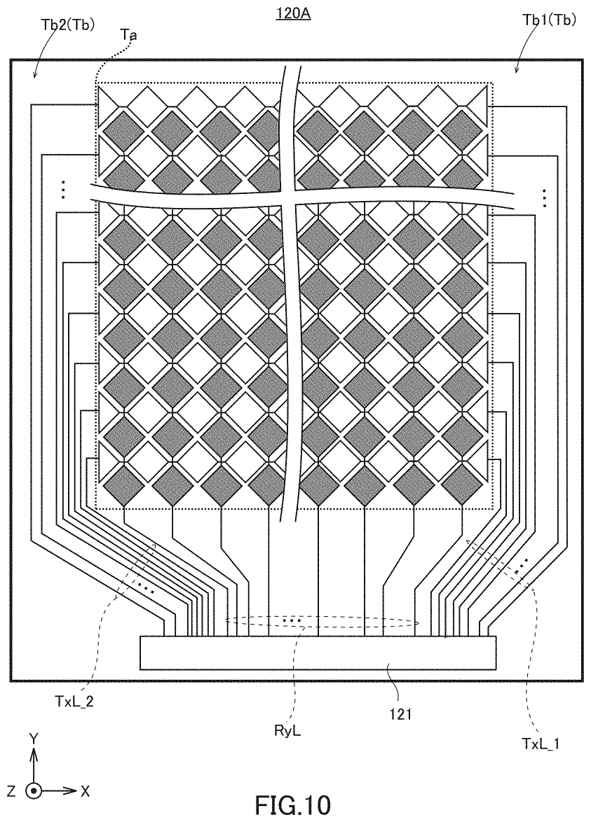

FIG. 10 is a schematic plan view illustrating a touch panel 120A in the present modification example. In FIG. 10, the same constituent members as those in Embodiment 1 (FIG. 4) are denoted by the same reference symbols as those in Embodiment 1.

As illustrated in FIG. 10, the second lines TxL_1, TxL_2 are connected to ends on both sides of the second electrodes Tx that are arrayed in the X-axis direction. The second electrode lines TxL_1 are arranged in an area Tb1 of the frame area Tb, the area Tb1 being on the right side with respect to the active area Ta; and the second electrode lines TxL_2 are arranged in an area Tb2 of the frame area Tb, the area Tb2 being on the left side with respect to the active area Ta.

In the case of this configuration, the second electrode lines TxL arranged in the areas Tb1 and Tb2 increase in number, as compared with the configuration illustrated in FIG. 4, and therefore the areas Tb1 and Tb2 have greater widths in the X-axis direction. In the case of this configuration, however, the time constant for each second electrode Tx, involving the second electrode line TxL, can be decreased, as compared with the configuration illustrated in FIG. 4, and this makes it possible to improve the touch detection accuracy.

(2) Embodiment 2 described above is described with reference to the configuration in which the ground electrode 1111 provided on the active matrix substrate 111, and the ground electrode 1133 provided on the counter substrate 113 are covered with the electrostatic protection member 20A, but the configuration may be such that the ground electrodes 1111 and 1133 are not covered. However, in this case, the configuration is such that the electrostatic protection member 20A is in contact with the bezel 115b connected to the ground potential line, and all of the side surfaces of the touch panel 120 and the active matrix substrate 111 are covered with the electrostatic protection member 20A.

The configuration disclosed herein can be described as follows.

A display device according to the first configuration includes: a display panel; and a display panel protection member that is made of a conductive material, is provided on at least a part of a side surface of the display panel, and is connected to a ground potential line.

According to the first configuration, the display device includes the display panel and the display panel protection member. The display panel protection member is connected to the ground potential line, and has conductivity. As at least a part of the side surface of the display panel is covered with the display panel protection member, it is unlikely that static electricity would enter the display panel from outside. Further, as compared with a case where a member for blocking static electricity from outside is formed in the frame area of the display panel, the foregoing configuration makes it possible to cause the display panel to have a smaller frame area.

The first configuration may be further characterized in that the display panel protection member contains a conductive resin (the second configuration).

The first configuration may be further characterized in that the display panel protection member contains a conductive paste (the third configuration).

Any one of the first to third configurations may be further characterized in further including: a touch panel provided on the display panel; and a touch panel protection member that is made of a conductive material, covers a side surface of the touch panel, and is connected with the display panel protection member (the fourth configuration).

According to the fourth configuration, the display device includes the touch panel on the display panel. The side surface of the touch panel is covered with the touch panel protection member connected with the display panel protection member. As compared with a case where a member for blocking static electricity is formed in the frame area of the touch panel, the foregoing configuration makes it possible to cause the touch panel to have a smaller frame area. Further, it is unlikely that static electricity from outside would enter the touch panel, which makes it possible to prevent a malfunction or a damage from being caused by static electricity of the touch panel.

The fourth configuration may be further characterized in that the display panel includes a backlight module arranged on a side opposite to the touch panel, wherein the backlight module includes a light source, and a frame that houses the light source, wherein the frame has conductivity and is connected with the ground potential line, and the display panel protection member is in contact with the frame (the fifth configuration).

According to the fifth configuration, the display panel includes a backlight module that includes a light source, and a frame that houses the light source. The frame of the backlight module is connected to the ground potential line, and is in contact with the display panel protection member. The display panel protection member and the touch panel protection member are therefore connected to the ground potential line via the frame. The side surface of the touch panel is covered with the touch panel protection member, and the side surface of the display panel including the backlight module is covered with the display panel protection member. It is therefore unlikely that static electricity would enter the touch panel and the display panel from outside, which makes it possible to cause the touch panel and the display panel to have narrower frames.

The fourth configuration may be further characterized in that the display panel includes an active matrix substrate, a counter substrate arranged so as to be opposed to the active matrix substrate; and a liquid crystal layer interposed between the active matrix substrate and the counter substrate; the active matrix substrate has a size greater than that of the counter substrate, the active matrix substrate includes a first ground electrode connected to the ground potential line in an area that does not overlap with the counter substrate when viewed in a plan view; the counter substrate includes a second ground electrode; and the display panel protection member covers a surface of the first ground electrode, and at least a part of a surface of the second ground electrode (the sixth configuration).

According to the sixth configuration, the display panel includes an active matrix substrate, a counter substrate that is smaller than the active matrix substrate, and a liquid crystal layer. The active matrix substrate includes a first ground electrode, and the counter substrate includes a second ground electrode. The first ground electrode and the second ground electrode are covered with the electrostatic protection member. Therefore, the electrostatic protection member and the second ground electrode are connected to the ground potential line via the first ground electrode. It is therefore unlikely that static electricity would enter the touch panel and the display panel from outside, which makes it possible to cause the touch panel and the display panel to have narrower frames.

Any one of the fourth to sixth configurations may be further characterized in that the touch panel includes: a substrate; a plurality of first electrodes that are arrayed in a first direction on one of surfaces of the substrate, and that are connected with one another; a plurality of second electrodes that are arrayed on the other surface of the substrate in a second direction that intersects with the first direction, and that are connected with one another; a first electrode line that is connected to the first electrode arranged at an end on one side, among the plurality of first electrodes; a second electrode line that is connected to at least the second electrode arranged at an end on one side, among the plurality of second electrodes; and a first metal film that is arranged on one of surfaces of the substrate, and that is connected with the ground potential line, wherein the plurality of first electrodes and the plurality of second electrodes are arranged in an active area that overlaps with a display area of the display panel when viewed in a plan view, the first metal film and the second electrode line are arranged in a first non-active area that is an area that does not overlap with the display area of the display panel when viewed in a plan view and is formed so as to be adjacent to the active area in the second direction, and the first metal film overlaps with the second electrode line when viewed in a plan view (the seventh configuration).

According to the seventh configuration, the touch panel has an active area that overlaps with the display area, and a first non-active area. A plurality of first electrodes are provided in the active area, on one of the surfaces of the substrate in the touch panel, and a first metal film is provided in the first non-active area. Further, a plurality of second electrodes are provided in the active area, on the other surface of the substrate, and a second electrode line is provided in the first non-active area. The first non-active area is an area that is formed so as to be adjacent to the active area, so as to be adjacent in the second direction in which the second electrodes are arrayed. The second electrode line leading out of the second electrode in the active area to the first non-active area is covered with the first metal film, with the substrate being interposed therebetween. As the first metal film is connected to the ground potential line, it is unlikely that electromagnetic noise from outside would enter the second electrode line, which makes it possible to obtain appropriate detection results.

The seventh configuration may be further characterized in that the touch panel includes: a second metal film that is arranged on the other surface of the substrate, and that is connected with the ground potential line; a first ground line that is arranged on one of the surfaces of the substrate, and that is connected with the ground potential line; and a second ground line that is arranged on the other surface of the substrate, and that is connected with the ground potential line, wherein the first electrode line, the second metal film, the first ground line, and the second ground line are arranged in a second non-active area that is an area that does not overlap with the display area of the display panel when viewed in a plan view, and that is formed so as to be adjacent to the active area in the first direction; the first metal film is provided in the first non-active area and the second non-active area; the second electrode line extends from the first non-active area to the second non-active area, so as to be arranged at a position that does not overlap with the first electrode line when viewed in a plan view; the first ground line and the second ground line are arranged so as to be opposed to each other between the first electrode line and the second electrode line when viewed in a plan view; and the second metal film is arranged in an area that overlaps with the first electrode line when viewed in a plan view (the eighth configuration).

According to the eighth configuration, the touch panel has a second non-active area, in addition to the active area and the first non-active area. The second non-active area is an area that is formed so as to be adjacent to the active area, so as to be adjacent in the first direction. The first ground line, the first electrode line, and the first metal film are provided in the second non-active area on one of the surfaces of the substrate in the touch panel, and the second metal film and the second ground line are provided in the second non-active area on the other surface of the substrate. The second electrode line extends from the first non-active area to the second non-active area, but does not overlap with the first electrode line in the second non-active area when viewed in a plan view. In the second non-active area, the first ground line and the second ground line are arranged between the first electrode line and the second electrode line, so as to be opposed to each other. Therefore, it is unlikely that capacitive coupling would occur between the first electrode line and the second electrode line. Besides, in the second non-active area, the first electrode line is covered with the second metal film connected to the ground potential line, and the second electrode line is covered with the first metal film connected to the ground potential line. Therefore, it is unlikely that electromagnetic noise from outside would enter the first electrode line and the second electrode line, whereby it is unlikely that a decrease in detection accuracy due to electromagnetic noise would occur.

### DESCRIPTION OF REFERENCE NUMERALS

1: display device
10, 10A: touch-panel-equipped display module
20, 20A to 20C: electrostatic protection member
111: active matrix substrate
112: liquid crystal layer
113: counter substrate
114a, 114b: polarizing plate
115: backlight module
115a: light source
115b: bezel
120: touch panel
121: controller
130: cover glass
140: adhesive layer
201: touch panel protection member
202: display panel protection member
211: first protection member
212: second protection member
1111, 1133: ground electrode
1241, 1242: metal line
Ry: first electrode
Tx: second electrode
RyL: first electrode line
TxL: second electrode line
Ta: active area
Tb, Tb1, Tb2: frame area

What is claimed is:

1. A display device comprising:
a display panel; and
a display panel protection member that is made of a conductive material,
wherein the display panel protection member covers at least a part of a side surface of the display panel and is connected to a ground potential line.

2. The display device according to claim 1,
wherein the display panel protection member contains a conductive resin.

3. The display device according to claim 1,
wherein the display panel protection member contains a conductive paste.

4. The display device according to claim 1, further comprising:
a touch panel provided on the display panel; and
a touch panel protection member that is made of a conductive material,
wherein the touch panel protection member covers a side surface of the touch panel and is connected with the display panel protection member.

5. The display device according to claim 4,
wherein the display panel includes a backlight module arranged on a side opposite to the touch panel,
the backlight module includes a light source, and a frame that houses the light source,
the frame has conductivity and is connected with the ground potential line, and
the display panel protection member is in contact with the frame.

6. The display device according to claim 4,
wherein the display panel includes an active matrix substrate, a counter substrate arranged so as to be opposed to the active matrix substrate, and a liquid crystal layer interposed between the active matrix substrate and the counter substrate,
the active matrix substrate has a size greater than that of the counter substrate, and the active matrix substrate includes a first ground electrode connected to the ground potential line in an area that does not overlap with the counter substrate when viewed in a plan view,
the counter substrate includes a second ground electrode, and
the display panel protection member covers a surface of the first ground electrode, and at least a part of a surface of the second ground electrode.

7. The display device according to claim 4,
wherein the touch panel includes:
a substrate;
a plurality of first electrodes that are arrayed in a first direction on one of surfaces of the substrate, and that are connected with one another;
a plurality of second electrodes that are arrayed on the other surface of the substrate in a second direction that intersects with the first direction, and that are connected with one another;
a first electrode line that is connected to the first electrode arranged at an end on one side, among the plurality of first electrodes;
a second electrode line that is connected to at least the second electrode arranged at an end on one side, among the plurality of second electrodes; and
a first metal film that is arranged on one of surfaces of the substrate, and that is connected with the ground potential line,
wherein the plurality of first electrodes and the plurality of second electrodes are arranged in an active area that overlaps with a display area of the display panel when viewed in a plan view,
the first metal film and the second electrode line are arranged in a first non-active area that is an area that does not overlap with the display area of the display panel when viewed in a plan view and is formed so as to be adjacent to the active area in the second direction, and
the first metal film overlaps with the second electrode line when viewed in a plan view.

8. The display device according to claim 7,
wherein the touch panel includes:
a second metal film that is arranged on the other surface of the substrate, and that is connected with the ground potential line;
a first ground line that is arranged on one of the surfaces of the substrate, and that is connected with the ground potential line; and
a second ground line that is arranged on the other surface of the substrate, and that is connected with the ground potential line,
wherein the first electrode line, the second metal film, the first ground line, and the second ground line are arranged in a second non-active area that is an area that does not overlap with the display area of the display panel when viewed in a plan view, and that is formed so as to be adjacent to the active area in the first direction,
the first metal film is provided in the first non-active area and the second non-active area,
the second electrode line extends from the first non-active area to the second non-active area, so as to be arranged at a position that does not overlap with the first electrode line when viewed in a plan view,
the first ground line and the second ground line are arranged so as to be opposed to each other between the first electrode line and the second electrode line when viewed in a plan view, and
the second metal film is arranged in an area that overlaps with the first electrode line when viewed in a plan view.
